(19) United States
(12) Patent Application Publication
(10) Pub. No.: US 2021/0312468 A1
(43) Pub. Date: Oct. 7, 2021

(54) SYSTEMS AND METHODS FOR COMPLIANCE TRACKING AND CERTIFICATION

(71) Applicant: Caiphi, Inc., Johns Island, SC (US)

(72) Inventors: Edward D. Jones, III, Johns Island, SC (US); Mark Sizelove, Napa, CA (US); Omprakash Gnawali, Houston, TX (US); Carolyn Hartley, Chapin, SC (US); David S. Miller, Bluffton, SC (US); Craig D. Maynard, Charleston, SC (US)

(21) Appl. No.: 17/221,650

(22) Filed: Apr. 2, 2021

Related U.S. Application Data
(60) Provisional application No. 63/005,634, filed on Apr. 6, 2020.

(51) Int. Cl. G06Q 30/00

(52) U.S. Cl. CPC G06Q 30/018

(57) ABSTRACT

A method, system, and computer-readable medium are disclosed for tracking plans for compliance within an organization. Each plan may be associated with one or more standards, each standard may be associated with one or more policies and one or more procedures for carrying out the one or more policies. A compliance dashboard for the organization is displayed on a display device, the compliance dashboard including, for each standard of each plan, a compliance status indicator representing a compliance status for a respective standard.

### CROSS-REFERENCE TO RELATED APPLICATIONS

This application claims the benefit of U.S. Provisional App. No. 63/005,634, filed Apr. 6, 2020, for SYSTEMS AND METHODS FOR FACILITATING STANDARD COMPLIANCE, which is incorporated herein by reference.

### BACKGROUND

Emergency response planning for disasters is crucial in many industries, particularly healthcare. Not only is having a detailed emergency plan necessary to save lives, but some government agencies require that emergency plans be fully tested and certified on an annual basis. For example, the Centers for Medicare & Medicaid Services (CMS) has published emergency preparedness rules for health providers participating in Medicare and Medicaid. The rules requires facilities to establish and maintain consistent emergency preparedness policies and procedures in order to increase patient safety during emergencies. Failure to abide by the rules can result in the loss of eligibility to participate in Medicare and Medicaid.

For large facilities, emergency preparedness plans can be complex. Furthermore, some healthcare companies are responsible for multiple facilities, each of which has its own emergency preparedness plan based on the unique hazards of a particular city, state, or region. Thus, tracking compliance with emergency preparedness policies and procedures for certification purposes can be a daunting management task. A facility can fall out of compliance due to the size and scope of the management task, resulting in fines or the loss of right to participate in government programs.

Currently, no system exists to allow a healthcare company to develop, approve, train, and test emergency preparedness and other plans, as well as to track compliance with, and facilitate certification of, such plans.

### BRIEF SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one aspect, a method for compliance tracking includes accessing one or more plans to be tracked for compliance within an organization. Each plan may be associated with one or more standards, and each standard may be associated with one or more policies and one or more procedures for carrying out the one or more policies. The method may further include displaying a compliance dashboard for the organization on a display device, the compliance dashboard including, for each standard of each plan, a compliance status indicator representing a compliance status for a respective standard. Each standard may be associated with a person responsible for ensuring compliance with the standard.

In some embodiments, the method includes receiving a policy document setting forth a particular policy for a particular standard, and receiving a procedure document setting forth a particular procedure for carrying out the particular policy. The method may further include determining that a compliance status for the particular standard has changed in response to the particular policy and procedure being at least one of approved, trained, or tested. The method may also include updating the compliance status indicator corresponding to the particular standard in the compliance dashboard in response to the change in compliance status.

In one example, the organization is a healthcare organization, and the one or more plans include an emergency preparedness plan for the healthcare organization. The compliance status may be selected from the group consisting of incomplete, approved, trained, and tested, with the compliance status being set to incomplete by default.

In various embodiments, the compliance status is changed in response to an indication from the responsible person that the particular policy and procedure have been approved, trained, or tested. The compliance status may be changed automatically in response to the indication by the responsible person. In other embodiments, the compliance status is changed by an administrator or a designee of the administrator in response to the indication by the responsible person.

Each compliance status indicator in the compliance dashboard may be color-coded. In one example, red is used for a compliance status of incomplete, yellow is used for a compliance status of approved, blue is used for a compliance status of trained, and green is used for a compliance status of tested.

In some embodiments, the compliance dashboard arranges a plurality of compliance status indicators into a bar graph. A first axis of the bar graph may correspond to the one or more plans for the organization and a second axis of the bar graph may correspond to the one or more standards for a given plan. Similar compliance status indicators may be grouped together along the second axis of the bar graph with compliance status indicators indicating full compliance being grouped together on one side of the second axis. In some cases, the dashboard may include, along the second axis, an indication of a percentage of standards for the given plan for which full compliance has been reached. The dashboard may also include a numerical indication of how many of the one or more standards for a given plan have reached full compliance, and/or a numerical indication of how many of the one or more standards are associated with a given plan.

In one embodiment, in response to receiving a user selection of a compliance status indicator corresponding to a selected standard, the method includes displaying an indication of a person responsible for compliance with the selected standard. The method may further include, in response to an administrator selecting compliance status indicator corresponding to a selected standard from the compliance dashboard, displaying a compliance checklist including: a mechanism for viewing the selected standard; a mechanism for viewing a policy document for the selected standard; a mechanism for viewing a procedure document for the selected standard; and a mechanism for changing the compliance status.

The method may further include displaying a compliance checklist to a person responsible for ensuring compliance with a selected standard. The compliance checklist may include a mechanism for providing a policy document for the selected standard; and a mechanism for providing a procedure document for the selected standard, as well as providing a mechanism for viewing a predefined template for one or more of the policy or procedure documents for the particular standard.

In some embodiments, the method includes updating the compliance status indicator in the compliance dashboard for the particular standard in response to real-time data received for the particular standard. The particular standard may include, without limitation, a power standard, a heating standard, and a lighting standard. The method may further include notifying a person responsible for ensuring compliance with the particular standard in response to updating an associated compliance status indicator.

In various embodiments, the method includes using machine learning (e.g., a neural network) to determine one or more vulnerabilities to compliance by the organization with the one or more plans based on assessments of prior plans.

In some embodiments, the method may include providing at least a subset of a plan to a requester based on a role of the requester. Alternatively, or in addition, the method may include inhibiting access to the compliance dashboard or subsets of information related to compliance based on a role of a requestor.

The method may further include generating a compliance report including at least a subset of the one or more standards of the one or more plans for the organization.

In one or more embodiments, the method includes providing a mechanism for selecting two or more organizations from a plurality of organizations; and displaying a compliance dashboard for each of the selected two or more organizations on a display device, for each standard of each plan, a compliance status indicator representing a compliance status for a respective standard.

In another aspect, a computer-readable medium storing program code that, when executed by a processor, cause the processor to perform operations, the operations including: accessing one or more plans to be tracked for compliance within an organization, each plan being associated with one or more standards, each standard being associated with one or more policies and one or more procedures for carrying out the one or more policies; causing a compliance dashboard for the organization to be displayed a display device, the compliance dashboard including, for each standard of each plan, a compliance status indicator representing a compliance status for a respective standard; receiving a policy document setting forth a particular policy for a particular standard; receiving a procedure document setting forth a particular procedure for carrying out the particular policy; determining that a compliance status for the particular standard has changed in response to the particular policy and procedure being at least one of approved, trained, or tested; and updating the compliance status indicator corresponding to the particular standard in the compliance dashboard in response to the change in compliance status.

In yet another aspect, a system includes one or more processors and one or more memory devices including instructions that, when executed by the one or more processors, cause the one or more processors to perform a method including: accessing one or more plans to be tracked for compliance within an organization, each plan being associated with one or more standards, each standard being associated with one or more policies and one or more procedures for carrying out the one or more policies; displaying a compliance dashboard for the organization on a display device, the compliance dashboard including, for each standard of each plan, a compliance status indicator representing a compliance status for a respective standard; receiving a policy document setting forth a particular policy for a particular standard; receiving a procedure document setting forth a particular procedure for carrying out the particular policy; determining that a compliance status for the particular standard has changed in response to the particular policy and procedure being at least one of approved, trained, or tested; and updating the compliance status indicator corresponding to the particular standard in the compliance dashboard in response to the change in compliance status.

These and other aspects and advantages will be described in detail with respect to the Figures.

### BRIEF DESCRIPTION OF THE DRAWINGS

The accompanying Figures and Examples are provided by way of illustration and not by way of limitation. The foregoing aspects and other features of the disclosure are explained in the following description, taken in connection with the accompanying exemplary figures relating to one or more embodiments, in which:

FIG. 1 is a hierarchical diagram of one or more plans to be tracked for compliance within an organization;

FIG. 2 is a schematic diagram of a compliance tracking system;

FIG. 3 is a graphical user interface including a compliance dashboard;

FIG. 4 is a graphical user interface including a compliance dashboard and information about a responsible person;

FIG. 5 is a graphical user interface including a compliance checklist;

FIG. 6 is a graphical user interface including a change report;

FIG. 7 is a schematic diagram of a compliance tracking system; and

FIG. 8 is a flowchart of a method for compliance tracking.

### DETAILED DESCRIPTION

For the purposes of promoting an understanding of the principles of the present disclosure, reference will now be made to various embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Disclosed herein is a compliance tracking system and method that tracks, in real-time, compliance survey, testing and certification requirements with various standards. In one example embodiment, the system allows emergency management personnel to build plans for any number of facilities, assign responsible persons to prepare detailed emergency plans, and upload policies and procedures into the system in order for the status to be tracked and updated as it moves from approval to training to testing.

The system may generate a color-coded “at-a-glance” dashboard to determine the progress of each category and requirement. As documents are completed, the system can generate a copy (e.g., PDF), by category, of the policies and procedures, which may be viewed in real time or downloaded to the user device and retained for off-line use.

The system can incorporate a checklist of requirements that allows users to upload emergency plan documents where they can be reviewed by emergency plan administrators for approval and subsequent implementation. As users make changes or updates to plan documents, the system updates a compliance log and records who responsible for what changes and the date of the specific change.

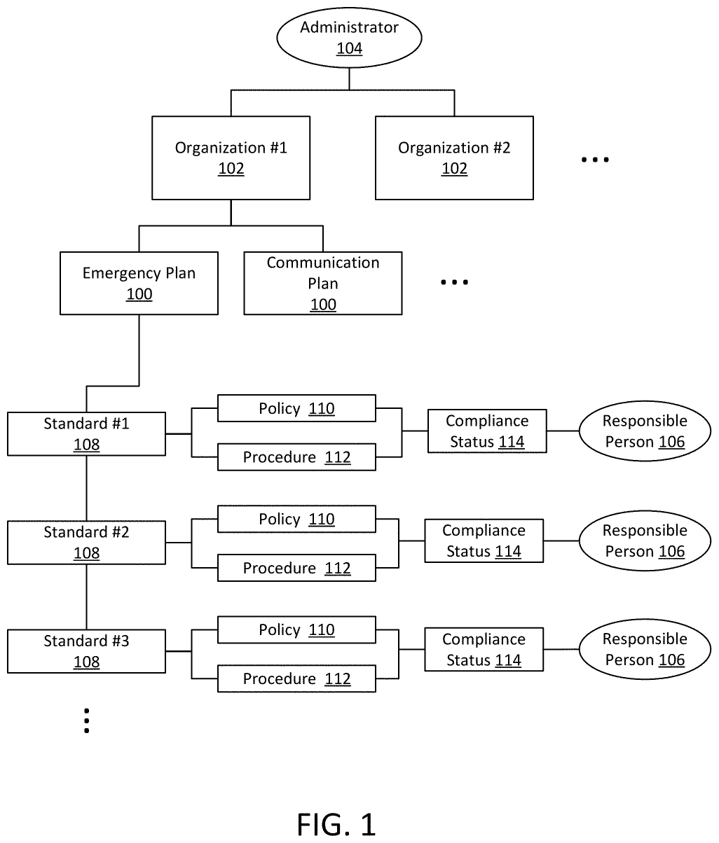

FIG. 1 is a hierarchical diagram of aspects of a plan 100 that may be tracked for compliance within an organization 102. The plan 100 could be an emergency preparedness plan in the context of a healthcare organization 102, such as a hospital, long term care (LTC) facility, transplant center, or the like. However, other types of organizations 102 could benefit from the principles of the present disclosure. Thus, although healthcare is used as an example in the following embodiments, the disclosure is not limited to such.

Any number of organizations 102 may have any number of plans 100 in the context of the present disclosure. In FIG. 1, two organizations 102 are shown, i.e., Organization #1 and Organization #2. Likewise, two plans 100 are shown, i.e., an Emergency Plan and a Communication Plan. A wide variety of other plans 100 may be included within the scope of the disclosure, including, without limitation, testing plans, training plans, and the like.

In some cases, one or more organizations 102 can be overseen by an administrator 104, who is ultimately responsible for compliance with the plans 100 of the organization 102. Such an administrator 104 could be, without limitation, a Chief Executive Officer (CEO) of the organization(s) 102, who may have the ultimate responsibility for reporting compliance to a government agency. In addition, there may be a number of other responsible persons 106, who are tasked with aspects of a plan 100, as described in greater detail below.

As illustrated, a plan 100 may be associated with a number of standards 108. The standards 108 could be government rules, such as the rules set forth by the Centers for Medicare & Medicaid Services (CMS) in seventeen Code of Federal Regulations (CFR) categories related to emergency preparedness for healthcare organizations. For example, 42 CFR § 483.73(a)(1) for long-term care facilities (LTCs) requires facility-based and community-based “all hazards” risk assessments. Compliance with such standards 108 is required in order for a healthcare facility to participate in Medicare and Medicaid. In other situations, the standards 108 could be dictated by state or local laws, different Federal agencies, trade organizations, and/or the like. For example, in connection with the Communication Plan, various standards 108 may pertain to compliance with the Health Insurance Portability and Accountability Act (HIPAA), such as, without limitation, a means, in the event of an evacuation, to release resident information as permitted under 45 CFR 164.510(b)(1)(ii), and/or a means of providing information about the general condition and location of residents under the facility's care as permitted under 45 CFR 164.510(b)(4).

In the present example, three standards 108 are illustrated, i.e., Standard #1, Standard #2, and Standard #3. However, those skilled in the art will recognize that any number of standards 108 could be included for a given plan 100.

In some embodiments, a particular standard 108 may be associated with a policy 110 for the organization 102 regarding the standard 108, as well as a procedure 112 for carrying out the policy 110. Preparing such policies 110 and procedures 112 may be the task of the responsible persons 106. As described in greater detail hereafter, a responsible person 106 may upload documents setting forth the policies 110 and procedures 112 for a given standard 108. Thereafter, the policies 110 and procedures 112 may be approved, personnel may be trained, and the policies 110 and procedures 112 may be tested as required for compliance.

Each standard 108 may also be associated with a compliance status 114 indicating the stage in a compliance process that the associated policy 110 and procedure 112 has reached. In one example, the compliance status 114 may include, without limitation, “incomplete” (i.e., the policies 110 and procedures 112 for a given standard 108 have not been provided by the responsible person 106), “approved” (i.e., the policies 110 and procedures 112 have been approved by a reviewing person, such as the administrator 104 or the like), “trained” (i.e., personnel of the organization 102 have been trained on the policies 110 and procedures 112), and “tested” (i.e., the organization 102 had conducted testing of the policies 110 and procedures 112, such as in the context of a disaster preparedness drill). In the present example, a compliance status 114 of “tested” indicates full compliance with the given standard 108.

Those of skill in the art will recognize that other terminology may be substituted to describe the various compliance statuses 114, all of which are contemplated in the present disclosure. For example, the “approved” compliance status 114 could be replaced by “accepted,” “allowed,” “authorized,” “passed,” “ratified,” or the like. Accordingly, the specific words are less important than the concepts they convey. Furthermore, other compliance statuses 114 may be included depending on the organization 102 and the plans 100 and standards 108 in question. In one embodiment, the compliance status 114 for a given standard 108 defaults to “incomplete” (or the like) at the beginning of the compliance process.

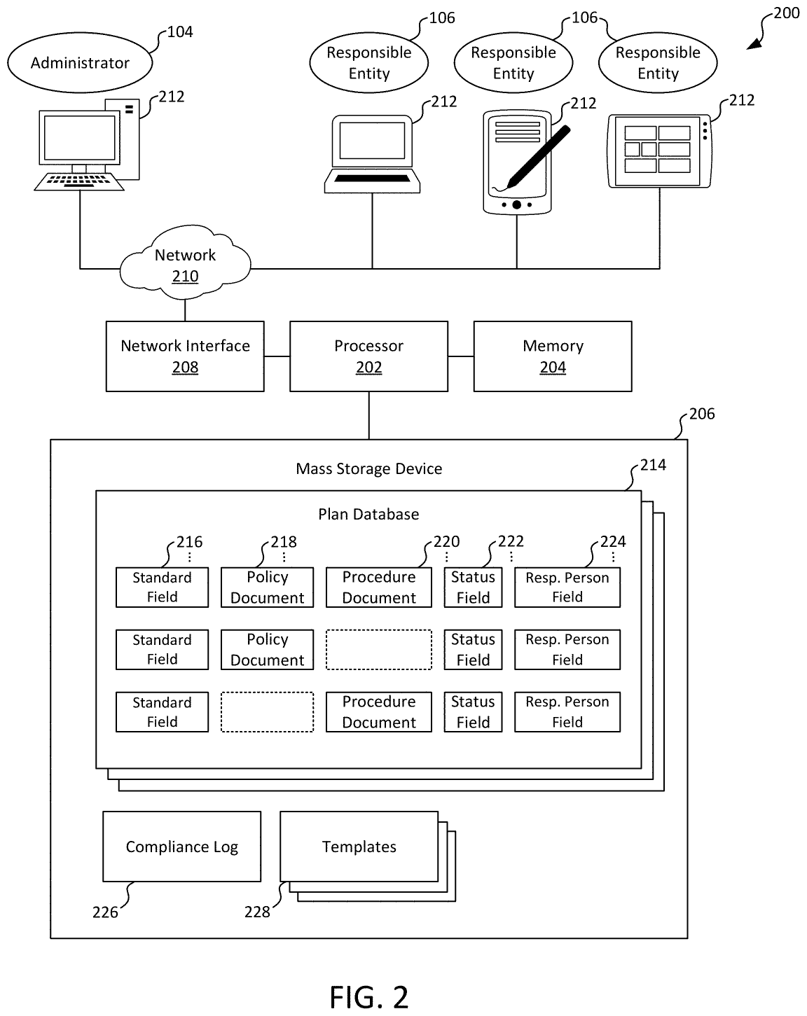

FIG. 2 is a schematic diagram of system 200 for compliance tracking according to one embodiment of the present disclosure. As illustrated, the system 200 may include a processor 202, also variously referred to as a central processing unit (CPU), microprocessor, microcontroller, or the like. While only one processor 202 is illustrated, those skilled in the art will recognize that multiple processors 202 distributed among one or more discrete computer systems may be used in some embodiments. Furthermore, the processor 202 may be a component of a virtual machine or a resource provided by a cloud computing system.

The processor 202 may be coupled to a memory 204 via a bus or other communication channel. The memory 204 may be implemented using any suitable combination of memory devices, such as random access memory (RAM), read-only memory (ROM), electrically-erasable read-only memory (EEPROM), etc., and may be physically embodied in multiple components at one or more discrete locations. The memory 204 may store instructions that are executed by the processor 202 to perform the processes disclosed herein.

The processor 202 may be further coupled to one or more mass storage devices 206, such as a hard drive, solid state drive (SSD), optical drive, or the like. The mass storage device 206 may be implemented using one or more physical devices located at one or more discrete locations and may be provided, for example, in the cloud.

In some embodiments, the processor 202 is coupled to a network interface 208, which may facilitate communication with a network 210. The network 210 may include, without limitation, a local area network (LAN) or a wide area network (WAN), such the Internet. The network 210 may be used to access various resources in the cloud, including, without limitation, processing resources and storage resources. The network interface 208 may implement various wired and wireless protocols as known to those skilled in the art.

In one embodiment, the network 210 may be used for accessing the system 200 by the administrator 104 and/or one or more responsible persons 106 via one or more computing devices 212, such as, without limitation, personal computers, and mobile devices (e.g., cellular telephones, laptops, and tablet computers). Each computing device 212 may include one or more processors, memories, hard drives, display interfaces, display devices (e.g., monitors) and the like, in order to execute software for accessing the system 200. In one embodiment, the software could be a web browser that access a web server (not shown) implemented by the system 200 using the processor 202 and memory 204. In other embodiments, the software could be a dedicated application running on one or more of the computing devices 212. In either case, aspects of the system 200 may be provided to organizations 102 as Software as a service (SaaS).

As illustrated, the mass storage device 206 may be used to store representations of a plan 100 in a plan database 214. The plan database 214 may include, without limitation, a relational database, a hierarchical database, a network database, an object-oriented database, and/or the like. In the present example, a standard 108 may be represented in a standard field 216 as text, a hypertext link, or the like. A policy 110 and procedure 112 may be represented the form of a policy document 218 and procedure document 220, respectively. The policy and procedure documents 218, 220 may be stored in a portable document format (PDF) or another suitable format known in the art. In the present example, some policy and procedure documents 218, 220 are shown in dashed lines indicating that they have not yet been uploaded to the system 200 by a responsible person 106.

In one embodiment, the compliance status 114 of a plan 100 may be represented in a status field 222 as text, a numeral value, or the like. In addition, information concerning the responsible person 106 may be represented in a responsible person field 224, which may include, without limitation, a responsible person's name, role, contact information, or the like. Those skilled in the art will recognize that the foregoing is only one possible way in which a plan 100 may be represented in the system 200. Many other data structures and/or organizational methodologies may be used within the scope of the disclosure.

In some embodiments, the mass storage device 206 may further be used to store one or more compliance logs 226 and one or more templates 228, as will be described more fully hereafter.

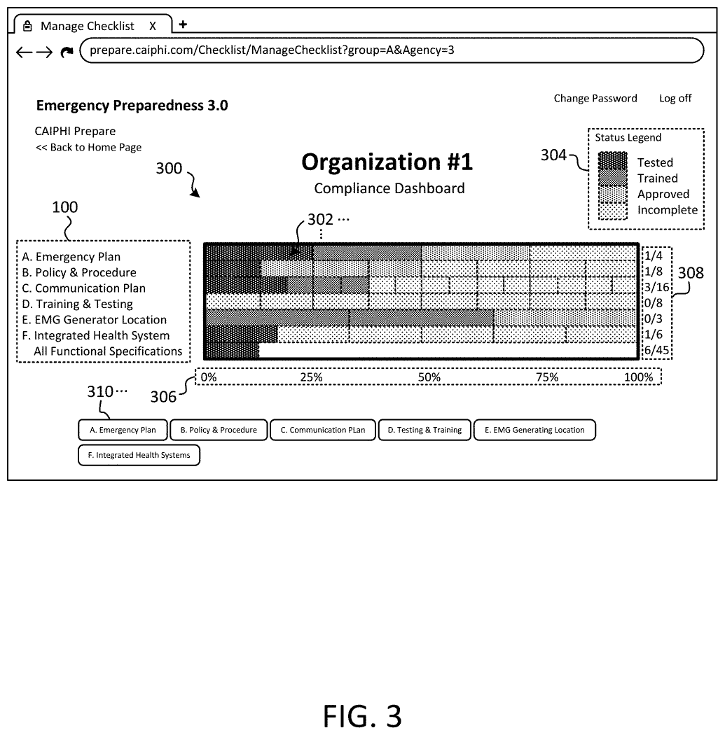

FIG. 3 is a graphical user interface (GUI) presented on a display device, such as a display device of one of the computing devices 212 shown in FIG. 2. In the present example, the GUI is presented in the context of a web browser. Although not required in every embodiment, a web interface provides a mechanism by which a variety of computing devices 212 may access the system 200 without requiring specialized applications to be developed and maintained for each computing device 212.

In one embodiment, the GUI includes a compliance dashboard 300 for an organization 102, such as Organization #1. In other embodiments (not shown), the GUI may include multiple compliance dashboards 300 for multiple organizations 102.

In the illustrated example, the compliance dashboard 300 includes a number of compliance status indicators 302. Each compliance status indicator 302 may graphically represent a compliance status 114 for standard 108 of each plan 100 for an organization 102. In other embodiments, the compliance dashboard 300 may include compliance status indicators 302 that graphically represent the compliance statuses 114 for subset of statuses 114 and/or for a subset of plans 100 or standards 108.

The compliance status indicators 302 may be colored-coded to visually convey, at a glance, each respective compliance status 114. In one example, red may be used to represent a compliance status 114 of “incomplete,” yellow may be used to represent a compliance status 114 of “approved,” blue may be used to represent a compliance status 114 of “trained,” and green may be used to represent full compliance, e.g., a compliance status 114 of “tested.” Of course, other colors could be used in different embodiments. In addition, patterns or other visual mechanisms can be used in lieu of color. In some embodiments, a status legend 304 may be provided to show the color, pattern, or other representation of a particular compliance status 114.

In one embodiment, the compliance dashboard 300 may be configured as a set of bar graphs arranged in rows, where each row corresponds to one of the plans 100 for the organization 102 and each segment (compliance status indicator 302) represents a standard 108. For example, in the present example, the top row of the bar graph corresponds to an Emergency Plan containing four segments, each segment corresponding to one of the four standards 108 for an emergency plan as specified in 42 CFR § 483.73(a)(1)-(4).

The segments of a row need not be distinguishable from each other in every embodiment. For example, if all of the segments in a given row are incomplete and therefore colored red, the row may appear as a solid red bar. In other embodiments, as shown in FIG. 3, divisions between segments may be included, using, for instance, dashed lines or the like.

In some embodiments, a compliance status indicator 302 for a particular standard 108 may be in a fixed location of the compliance dashboard 300. Alternatively, the locations of the compliance status indicators 302 for a given plan 100 may be dynamically rearranged, such that compliance status indicators 302 corresponding to the same compliance status 114 (e.g., tested, trained, approved, incomplete) are grouped together.

Furthermore, in some embodiments, groups of similar compliance status indicators 302 may be arranged along a given row in a particular order. For example, compliance status indicators 302 corresponding to a tested compliance status 114 being displayed to the left, followed by compliance status indicators 302 corresponding to trained, approved, and incomplete compliance statuses 114, respectively. In such an embodiment, a reviewer of a compliance dashboard 300 for an organization 102 may easily see, at a glance, the proportion of standards 108 that have been tested for a given plan 100.

In one configuration, a numerical gauge 306 may be displayed along the horizontal axis, showing, at intervals, the percentage of standards 108 that have reached a particular compliance status 114. For example, in the case of the Emergency Plan, an administrator 104 may see that 25% of the standards have been tested. In addition, a bar graph may be included to show the overall compliance of the organization 102 with a set of plans 100.

In some embodiments, the compliance dashboard 300 may include numerical indications 308 of how many of the one or more standards 108 for a given plan 100 have a particular compliance status 114, such as tested. In some cases, the numerical indications 308 may further indicate the number of standards 108 for the given plan. For example, in the case of the Emergency Plan, the numerical indications 308 convey that one standard of four have reached the compliance status 114 of tested.

In the present example, compliance status indicators 302 may have different horizontal widths depending on the number of standards 108 for a given plan 100. This allows compliance with different plans 100 to be directly compared along a common axis. For example, the Emergency Plan has four standards 108, whereas the Communication Plan has sixteen. Accordingly, the compliance status indicators 302 of the Communication Plan are one-quarter the width of those for the Emergency Plan.

The present disclosure is not limited to the exemplary compliance status dashboard 300 shown in FIG. 3. In other embodiments, compliance status indicators 302 may be arranged in vertical columns along a horizontal axis representing different plans 100. Compliance status indicators 302 need not be touching each other, need not be of varying size, and need not be configured in the form of a bar graph. However, an administrator 104 or other reviewer should be able view the compliance dashboard 300 and determine, at a glance, the overall compliance of the organization, which may be accomplished by associating color-coded (or otherwise differentiated) compliance status indicators 302 using a logical arrangement in the compliance dashboard 300. The overall color, pattern, shape, or other attribute of the compliance status indicators 302 will alert administrator 104 to compliance issues that may prevent the organization from achieving certification.

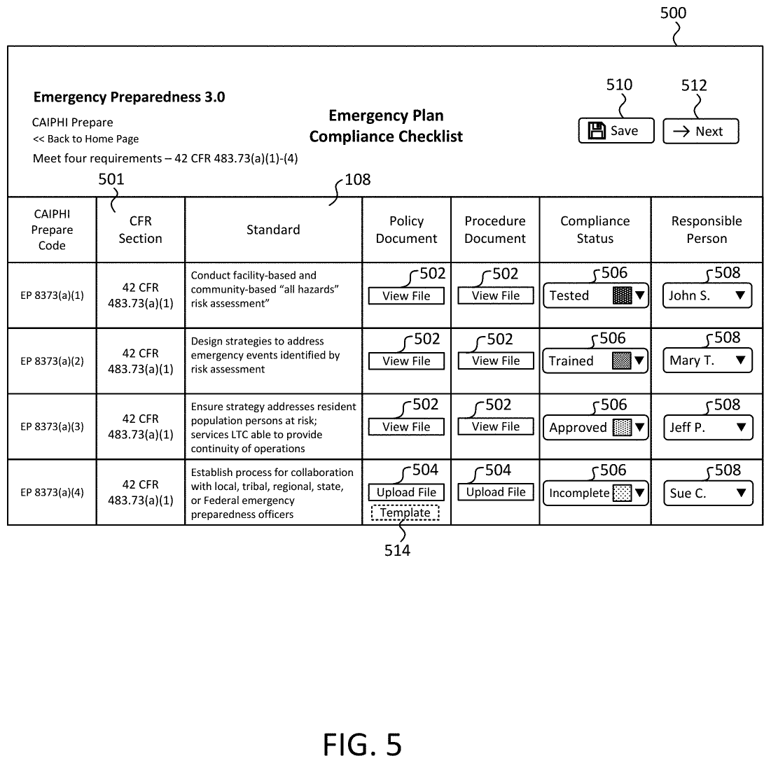

In some embodiments, the GUI may display a plurality of buttons, links, or like mechanisms 310 for displaying a corresponding compliance checklist, as will be described in greater detail with respect to FIG. 5.

The GUI may include one or more mechanisms (not shown) for enabling an administrator 104 or the like to selectively display compliance multiple dashboards 300 for one or more organizations 102 at the same time or successively within the same GUI or different GUIs.

Likewise, in certain embodiments, a single compliance dashboard 300 may be used to aggregate the compliance statuses 114 of multiple organizations 104 overseen by the administrator 104. This may be done in one example by using additional colors for color-coding the respective compliance status indicators 302. For example, if two or more organizations 104 have achieved full compliance with the same standard 102, the corresponding compliance status indicator 302 may still be green. However, if the compliance statuses 114 for a given standard 102 for two organizations 104 are mixed, i.e., one organization 104 has achieved an “approved” compliance status 114 normally indicated by yellow and another organization 104 has an “incomplete” compliance status 114 normally indicated by red, the compliance status indicator 302 for the two organizations 104 may be orange.

In still other embodiments, a compliance status indicator 302, itself, may be represented as a bar graph showing multiple colors corresponding to the compliance statuses 114 of each organization 104. In yet another embodiment, the system 200 may perform an averaging (or other formula) to determine an overall compliance status 114 to be represented by a compliance status indicator 302 for multiple organizations 104. In some embodiments, a numeral indicator (not shown) of an aggregated compliance status 114 for multiple organizations 104 may be displayed within a compliance status indicator 302, the numerical indicator displaying the number of fully compliant organizations 104, a percentage of fully compliant organizations 104, or the like.

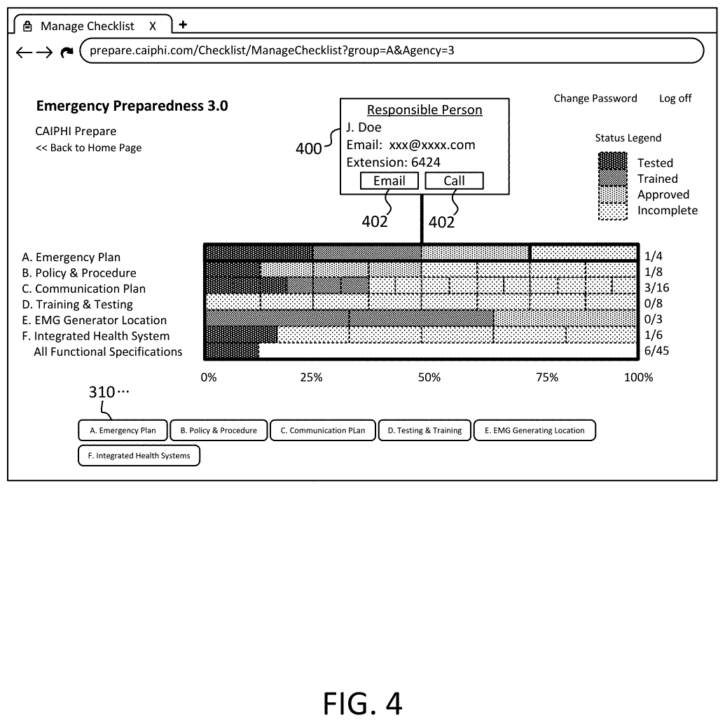

Referring now to FIG. 4, an administrator 104, after reviewing the compliance statuses 114, may desire to communicate with the corresponding responsible person 106. In one embodiment, the administrator 104 may select (e.g., “click on”) a particular plan 100 and/or one of the compliance status indicators 302. In response, or after a further action, the system 200 may display information 400 about the responsible person 106, which may be obtained, for example, from the plan database 214 of FIG. 2. The information 400 may include, without limitation, the responsible person's name, role, email address, telephone number, and/or other contact information.

In some embodiments, the system 200 may provide a mechanism 402 to email and/or call the responsible person 106. In the case of email, activating the mechanism 402 may cause a pre-populated email message to appear addressed to the responsible person and containing, in some embodiments, an appropriate subject line and/or text. In the case of a call, the system 200 may automatically dial the telephone number or extension of the responsible person 106. In such a way, the administrator 104 will be able to follow up with the responsible person 106 about a particular compliance status 114.

Referring to FIG. 5, the administrator 104 may select a plan 100, either from the dashboard 300 or by selecting one of the mechanisms 310 shown in FIG. 3. In response, the system 200 may display a compliance checklist 500 for the selected plan 100. The compliance checklist 500 may provide detailed information about the selected plan 100, including, without limitation, a recitation or summary of the standards 108 for the selected plan 100, links 501 to a corresponding regulation articulating the standard 108, and/or the like. The information may be obtained, in some embodiments, from the standard field 216 of the plan database 214 shown in FIG. 2. In some embodiments, a user may be able to scroll through the text of the standard 108 and/or click on a link 501 to the standard 108. In some embodiments, the link 501 may direct the user to a third party's website, such as a website maintained by a government agency.

The checklist 500 may provide a mechanism 502 (e.g., button or link) to view a previously uploaded policy document 218 and/or procedure document 220, as stored or referenced in the plan database 214. The checklist 500 may also provide a mechanism 504 (e.g., button or link) to upload a new policy document 218 and/or procedure document 220. The upload mechanism 504 may display a list of files from which the user may select.

In one embodiment, the checklist 500 may include a further mechanism 506 (e.g., button or link) for viewing and/or changing the current compliance status 114 for a given standard 108. The mechanism 506 may be color-coded according to the corresponding compliance status 114. Depending on the user's access rights, the compliance status 114 may be changeable using the mechanism 506. In some embodiments, only the administrator 104 or a designee of the administrator is able to change the compliance status 114. In other embodiments, a responsible person 106 may be authorized to change a compliance status 114.

The compliance checklist 500 may further include a mechanism 508 (e.g., button or link) for viewing and/or changing the current responsible person 106 for a selected standard 108. Changing the responsible person 106 may be limited to administrators 104, a designee of the administrator, or some other party with sufficient access rights.

In one embodiment, the compliance checklist includes a mechanism 510 (e.g., button or link) for saving any changes made in a current session, as well as a mechanism 512 (e.g., button or link) for switching to the compliance checklist 500 for a different plan 100.

In some embodiments, responsible persons 106 may be able to view and/or update at least a portion of a compliance checklist 500 containing the standard(s) 108 for which they are responsible. Such a checklist 500 may include the mechanisms 502, 504 for viewing and/or uploading policy and procedure documents 218, 220, respectively. Responsible persons 106 may be able to see, but not modify, the compliance status in some embodiments.

To assist in preparing the policy and procedure documents 218, 220, the responsible person 106 may be able to retrieve, via a mechanism 514 (e.g., button or link), one or more predefined templates 228 from the mass storage device 206. The predefined templates 228 may be stored in an editable format, such as Microsoft Word, which may allow the responsible person 106 to customize the predefined template 228 for the particular organization 102. The customized template 228 may be saved, in one embodiment, as a PDF document that can be automatically or manually uploaded to the system 200.

After the responsible person 106 has uploaded the policy and procedure documents 218, 220, the compliance status 114 may be changed from “incomplete” to “approved” upon approval by a reviewer, such as the administrator 104. This may occur automatically in response the reviewer indicating that the policies and procedures 110, 112 reflected in the policy and procedure documents 218, 220 have been approved. Alternatively, changing the compliance status 114 may be performed by the administrator 104 upon an indication of approval by another reviewer.

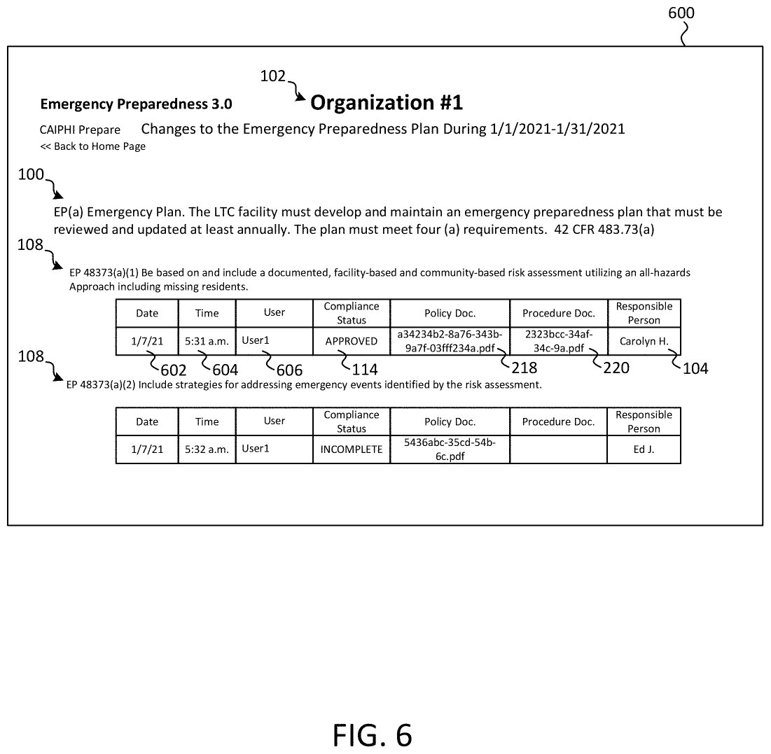

FIG. 6 illustrates a change report 600 generated from the compliance log of FIG. 2. In one embodiment, as users add or make changes to policy or procedure documents 218, 220, add or change responsible persons, and/or change compliance statuses 114, the system 200 makes a record in the compliance log 226 and records who is responsible for what changes and the date and/or time of the specific change. The compliance log 226 may be stored in any suitable machine-readable or human-readable format, including a database, an eXensible Markup Language (XML) document, or the like. In some embodiments, the change report 600 and compliance log 226 are the same document.

The change report 600 in the present example is in the form of a text-formatted report, which can be read by a user. In may be generated from the compliance log 226 and may be displayed in whole or part through the user specification of various filters, e.g., time/date range, standard 108, compliance status 114, role, or the like.

The illustrated change report 600 may include, without limitation, indications of one or more of an organization 102, a plan 100, a standard 108, a date 602 of a change, a time 604 of the change, a user 606 that made the change, a compliance status 114, a policy document 218 (e.g., link and/or file name), a procedure document 220 (e.g., link and/or file name), and/or responsible person 106.

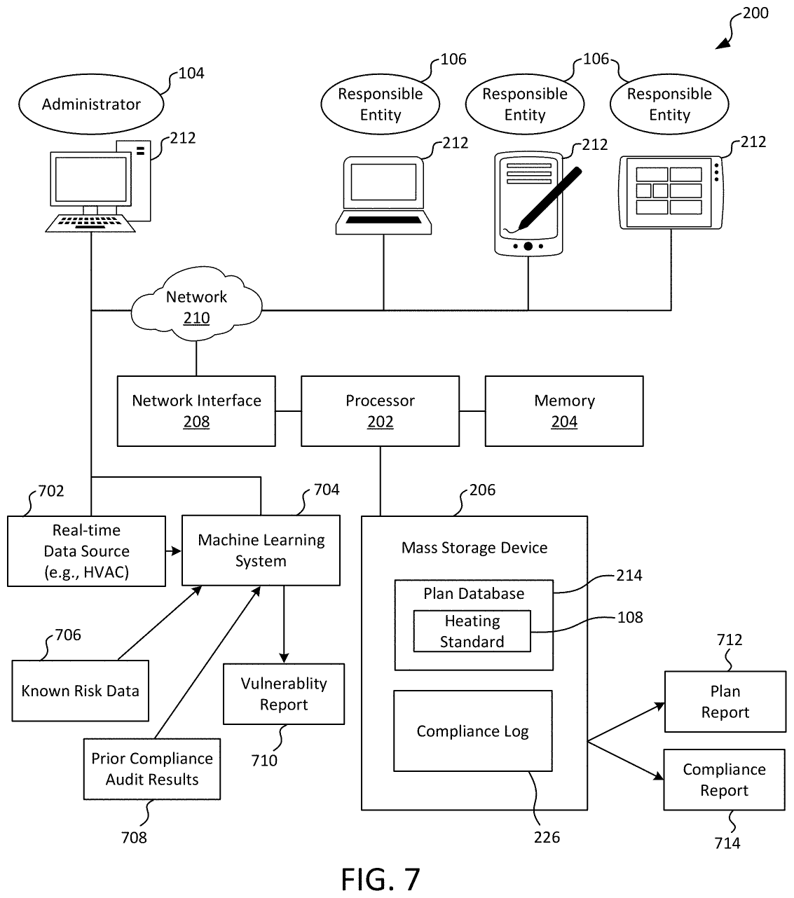

As illustrated in FIG. 7, some standards 108 may relate to the current operation of a real-time data source 702 such as a Heating, Ventilation, and Air Conditioning (HVAC) system. For example, a standard 108 may specify that the HVAC system maintain a room temperature of at least 70 degrees Fahrenheit. The HVAC system may include thermometers (not shown) throughout a facility and provide real-time temperature readings. Other standards 108 potentially associated with real-time data sources 702 may include, without limitation, power standards and lighting standards.

In one embodiment, the processor 202 receives real-time data from the real-time data source 702 relevant to the standard 108. If the real-time data fails to comply with the standard 108, the system may alert or notify the administrator 104 and/or responsible person 106 for the standard 108 and/or update the compliance status 114 for the particular standard 108. An alert may include, without limitation, an email, text message, voicemail, and/or changed compliance status indicator 302 in the compliance dashboard 300. Alternatively, or in addition, the system 200 may store an indication of a compliance failure in the compliance log 226.

FIG. 7 also illustrates the application of a machine learning system 704 to the above-described system 200. The machine learning system 704 may employ an artificial intelligence algorithm, such as supervised machine learning algorithm, which may be embodied as a Deep Neural Network (DNN), Convolutional Neural Network (CNN), or the like. In some embodiments, other forms of artificial intelligence may be used, such as fuzzy systems, evolutionary computing (e.g., genetic algorithms, differential evolution), metaheuristic and swarm intelligence, probabilistic methods (e.g., Bayesian networks, Hidden Markov models, Kalman filters), inverse problems, linear or non-linear optimization, and/or the like. The machine learning system 704 may be a component of the system 200 or accessed remotely via the network 210, as illustrated.

In one embodiment, the machine learning system 704 accesses one or more real-time data source(s) 702, the plan database 214, the compliance log 226, a set of known risk data 706 (including, without limitation, emergency risks common to the city, state, or region at which the organization 102 or a particular facility of the organization 102 is located), and a set of prior compliance audit results 708 (including, without limitation, data from prior compliance audits for the organization 102 or other similar organizations including reasons why one or more plans 100 failed certification). Based on the foregoing data, the machine learning system 704 identifies one or more vulnerabilities of a plan 100 or plans 100 of the organization 102. The vulnerabilities may include, without limitation, a risk of future non-compliance, a risk of failing to achieve compliance certification, and/or the like. The one or more vulnerabilities may be reported to the administrator 104 or other authorized individual in the form of a vulnerability report 710.

In some embodiments, the system 200 may generate a number of additional reports. For example, the system 200 may generate a plan report 712, which may include one or more policy or procedure documents 118, 220 or portions thereof for one or more standards 108. The plan report 712 may be viewed in real-time or downloaded to a user device and retained for off-line use.

The plan report 712 may be filtered, at least in part, based on the role of the requestor and the context of the request. For example, in an emergency, an employee in a hospital kitchen may desire to obtain the current emergency procedures in the event of a fire. The employee does not need a full report of the fire procedures for the organization, but only that portion of the fire procedures that pertain to the kitchen. In such an embodiment, the system 200 may access the plan database 214 and retrieve and/or filter the appropriate procedure documents 220 for the particular emergency and the role of the employee. Filtering may include inhibiting the employee from accessing data which is irrelevant, sensitive, or otherwise not applicable to the employee.

By contrast, the administrator 104 may be authorized to access all policy and procedure data corresponding to the organization(s) 102 for which the administrator 104 is responsible. The administrator 104 may be allowed to filter the data in various ways (e.g., topically, by keyword, etc.) to obtain the portions of the data (e.g., one or more policy or procedure documents 218, 220 or portions thereof) that the administrator 104 requires in performance of their role. Likewise, the responsible persons 106 may have access to the data pertaining to the plan(s) 100 and/or standard(s) 108 for which they are responsible.

In one embodiment, the system 200 may also produce a compliance report 714 certifying that at least a subset of the one or more standards of the one or more plans for the organization are fully compliant (e.g., “tested” in the present example). The compliance report 714 may be accessible to the administrator and/or a designee of the administrator and may be provided, for example, to a reviewing body for certification and/or in the context of a compliance audit. The compliance report 712 may include one or more components of the compliance dashboard 300 and the change report 600, such as an indications of one or more organizations 102, plans 100, standards 108, compliance statuses 114, policy documents 218, procedure documents 220, and/or responsible persons 106.

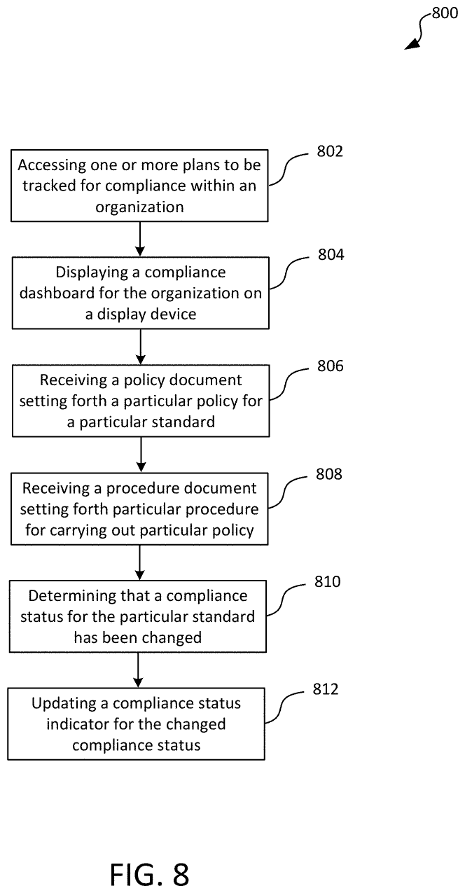

FIG. 8 is a flowchart of a method 800 for compliance tracking as performed by the system 200 of FIG. 2. The system 200 begins by accessing 802 one or more plans to be tracked for compliance within an organization, each plan being associated with one or more standards, each standard being associated with one or more policies and one or more procedures for carrying out the one or more policies. The system 200 continues by displaying 804 a compliance dashboard for the organization on a display device, the compliance dashboard including, for each standard of each plan, a compliance status indicator representing a compliance status for a respective standard.

In one embodiment, the system 200 continues by receiving 806 a policy document setting forth a particular policy for a particular standard, as well as receiving 808 a procedure document setting forth a particular procedure for carrying out the particular policy. The policy and procedure documents may be provided, for example, by a person responsible for compliance with the particular standard.

The system 200 may continue by determining 810 that a compliance status for the particular standard has changed in response to the particular policy and procedure being at least one of approved, trained, or tested. Thereafter, the system 200 proceeds with updating 812 the compliance status indicator in the compliance dashboard for in response to the change in compliance status.

In the foregoing disclosure, articles “a” and “an” are used to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

The present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless otherwise defined, all technical terms used herein have the same meaning as commonly understood by one of ordinary skill in the art to which this disclosure belongs.

Some of the infrastructure that can be used with embodiments disclosed herein is already available, such as general-purpose computers, computer programming tools and techniques, digital storage media, and communications networks. A computing device may include a processor such as a microprocessor, microcontroller, logic circuitry, or the like. The processor may include a special purpose processing device such as an ASIC, PAL, PLA, PLD, FPGA, or other customized or programmable device. The computing device may also include a computer-readable storage device such as non-volatile memory, static RAM, dynamic RAM, ROM, CD-ROM, disk, tape, magnetic, optical, flash memory, or other computer-readable storage medium.

Various aspects of certain embodiments may be implemented using hardware, software, firmware, or a combination thereof. As used herein, a software module or component may include any type of computer instruction or computer executable code located within or on a computer-readable storage medium. A software module may, for instance, comprise one or more physical or logical blocks of computer instructions, which may be organized as a routine, program, object, component, data structure, etc., which performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

What is claimed is:

1. A method comprising:
accessing one or more plans to be tracked for compliance within an organization, each plan being associated with one or more standards, each standard being associated with one or more policies and one or more procedures for carrying out the one or more policies;
displaying a compliance dashboard for the organization on a display device, the compliance dashboard including, for each standard of each plan, a compliance status indicator representing a compliance status for a respective standard;
receiving a policy document setting forth a particular policy for a particular standard;
receiving a procedure document setting forth a particular procedure for carrying out the particular policy;
determining that a compliance status for the particular standard has changed in response to the particular policy and procedure being at least one of approved, trained, or tested; and
updating the compliance status indicator corresponding to the particular standard in the compliance dashboard in response to the change in compliance status.

2. The method of claim 1, wherein the organization is a healthcare organization.

3. The method of claim 2, wherein the one or more plans include an emergency preparedness plan for the healthcare organization.

4. The method of claim 1, wherein the compliance status is selected from the group consisting of incomplete, approved, trained, and tested.

5. The method of claim 4, wherein the compliance status is set to incomplete by default.

6. The method of claim 1, wherein each standard is associated with a person responsible for ensuring compliance with the associated standard.

7. The method of claim 6, wherein the compliance status changes in response to an indication from the responsible person that the particular policy and procedure have been approved, trained, or tested.

8. The method of claim 7, wherein the compliance status is changed automatically in response to the indication by the responsible person.

9. The method of claim 7, wherein the compliance status is changed by an administrator or a designee of the administrator in response to the indication by the responsible person.

10. The method of claim 1, wherein each compliance status indicator in the compliance dashboard is color-coded.

11. The method of claim 10, wherein red is used for a compliance status of incomplete, yellow is used for a compliance status of approved, blue is used for a compliance status of trained, and green is used for a compliance status of tested.

12. The method of claim 1, wherein the compliance dashboard arranges a plurality of compliance status indicators into a bar graph, wherein a first axis of the bar graph corresponds to the one or more plans for the organization and a second axis of the bar graph corresponds to the one or more standards for a given plan.

13. The method of claim 12, wherein similar compliance status indicators are grouped together along the second axis of the bar graph with compliance status indicators indicating full compliance being grouped together on one side of the second axis.

14. The method of claim 13, further comprising:
displaying along the second axis an indication of a percentage of standards for the given plan for which full compliance has been reached.

15. The method of claim 1, further comprising:
displaying in the compliance dashboard a numerical indication of how many of the one or more standards for a given plan have reached full compliance.

16. The method of claim 1, further comprising:
displaying in the compliance dashboard a numerical indication of how many of the one or more standards are associated with a given plan.

17. The method of claim 1, further comprising:
in response to receiving a user selection of a compliance status indicator corresponding to a selected standard, displaying an indication of a person responsible for compliance with the selected standard.

18. The method of claim 1, further comprising:
in response to an administrator selecting compliance status indicator corresponding to a selected standard from the compliance dashboard, displaying a compliance checklist including:
a mechanism for viewing the selected standard;
a mechanism for viewing a policy document for the selected standard;
a mechanism for viewing a procedure document for the selected standard; and
a mechanism for changing the compliance status.

19. The method of claim 1, further comprising:
displaying a compliance checklist to a person responsible for ensuring compliance with a selected standard, wherein the compliance checklist includes:
a mechanism for providing a policy document for the selected standard; and
a mechanism for providing a procedure document for the selected standard.

20. The method of claim 19, further comprising:
providing a mechanism for viewing a predefined template for one or more of the policy or procedure documents for the particular standard.

21. The method of claim 1, further comprising:
updating the compliance status indicator in the compliance dashboard for the particular standard in response to real-time data received for the particular standard.

22. The method of claim 1, wherein the particular standard is selected from the group comprising a power standard, a heating standard, and a lighting standard.

23. The method of claim 1, further comprising:
notifying a person responsible for ensuring compliance with the particular standard in response to updating an associated compliance status indicator.

24. The method of claim 1, further comprising:
using machine learning to determine one or more vulnerabilities to compliance by the organization with the one or more plans based on assessments of prior plans.

25. The method of claim 1, further comprising:
providing at least a subset of a plan to a requester based on a role of the requester.

26. The method of claim 1, further comprising:
inhibiting access to the compliance dashboard or subsets of information related to compliance based on a role of a requestor.

27. The method of claim 1, wherein the display device is one or more of a computer monitor or a mobile device.

28. The method of claim 1, further comprising:
generating a compliance report certifying that at least a subset of the one or more standards of the one or more plans for the organization are fully compliant.

29. The method of claim 1, further comprising:
providing a mechanism for selecting two or more organizations from a plurality of organizations; and
displaying a compliance dashboard for each of the selected two or more organizations on a display device, for each standard of each plan, a compliance status indicator representing a compliance status for a respective standard.

30. The method of claim 1, wherein the compliance status dashboard displays at least one compliance status indicator representing an aggregated compliance status for multiple organizations for a given standard.

31. A computer-readable medium storing program code that, when executed by a processor, cause the processor to perform operations, the operations comprising:
accessing one or more plans to be tracked for compliance within an organization, each plan being associated with one or more standards, each standard being associated with one or more policies and one or more procedures for carrying out the one or more policies;
causing a compliance dashboard for the organization to be displayed a display device, the compliance dashboard including, for each standard of each plan, a compliance status indicator representing a compliance status for a respective standard;
receiving a policy document setting forth a particular policy for a particular standard;
receiving a procedure document setting forth a particular procedure for carrying out the particular policy;
determining that a compliance status for the particular standard has changed in response to the particular policy and procedure being at least one of approved, trained, or tested; and
updating the compliance status indicator corresponding to the particular standard in the compliance dashboard in response to the change in compliance status.

32. A system comprising:
one or more processors; and
one or more memory devices including instructions that, when executed by the one or more processors, cause the one or more processors to perform a method including:
accessing one or more plans to be tracked for compliance within an organization, each plan being associated with one or more standards, each standard being associated with one or more policies and one or more procedures for carrying out the one or more policies;
displaying a compliance dashboard for the organization on a display device, the compliance dashboard including, for each standard of each plan, a compliance status indicator representing a compliance status for a respective standard;
receiving a policy document setting forth a particular policy for a particular standard;
receiving a procedure document setting forth a particular procedure for carrying out the particular policy;
determining that a compliance status for the particular standard has changed in response to the particular policy and procedure being at least one of approved, trained, or tested; and
updating the compliance status indicator corresponding to the particular standard in the compliance dashboard in response to the change in compliance status.
